(19) United States
(12) Patent Application Publication
(10) Pub. No.: US 2025/0277773 A1
(43) Pub. Date: Sep. 4, 2025

(54) FLOW-PATH SWITCHING DEVICE AND LIQUID CHROMATOGRAPH

(71) Applicant: SHIMADZU CORPORATION, Kyoto (JP)

(72) Inventor: Jun YANAGIBAYASHI, Kyoto (JP)

(73) Assignee: SHIMADZU CORPORATION, Kyoto (JP)

(21) Appl. No.: 19/039,904

(22) Filed: Jan. 29, 2025

(30) Foreign Application Priority Data
Feb. 29, 2024 (JP) 2024-030625

(51) Int. Cl. G01N 30/20; G01N 30/02

(52) U.S. Cl. CPC G01N 30/20; G01N 2030/027; G01N 2030/201; G01N 2030/202

(57) ABSTRACT

A flow-path switching device includes a column pipe connected to the separation column, a first rotating body which has a first port and a first sliding surface, and in which a first through hole penetrating the first port and the first sliding surface is formed, and a second rotating body having a second sliding surface facing the first sliding surface, wherein the second rotating body is rotatable with the first sliding surface being in contact with the second sliding surface, and a second through hole is formed in the second rotating body, one end of the second through hole is connectable to the first through hole when a rotation position of the second rotating body with respect to the first rotating body is a first position, and another end of the second through hole is connected to the column pipe.

### BACKGROUND

### Technical Field

The present disclosure relates to a flow-path switching device and a liquid chromatograph.

### Description of Related Art

Mixing of a sample and a mobile phase and dispersing of the sample in the mobile phase in a portion other than a column is referred to as extra-column dispersion. In a case in which extra-column dispersion is in large scale, the column cannot exhibit separation ability to the maximum. In order to suppress extra-column dispersion, it is important to suppress disperse of the sample in a flow path such as a pipe used in a device. In a liquid chromatograph, an injection valve capable of switching flow paths through which a sample flows may be used. A groove is formed as a flow path in the injection valve.

### SUMMARY

The groove is formed when a cutting tool such as an end mill moves while rotating and being in contact with a rotor of the injection valve. Therefore, in a case in which the flow path is a groove, it is difficult to form the flow path having a small diameter due to the nature of machine processing. When the sample flows from a pipe having a small diameter into a groove having a large diameter, a turbulent flow is generated due to the difference in diameter, and the sample is dispersed.

Further, the surface of the flow path may wear over time due to the switching of the flow paths as an injection valve. Specifically, in a case in which having hydrophobicity, a sample may adhere to the surface of the worn flow path. Thus, carry-over may occur. Carry-over is a phenomenon in which, because a sample to be measured in one measurement remains in a liquid chromatograph, the remaining sample affects the result of the next measurement after the one measurement. When carry-over occurs, the credibility of the measurement result is degraded.

In an injection mechanism disclosed in JP 5291103 B2, a sample is injected with a needle inserted into a needle insertion path of a direct injection valve. According to JP 5291103 B2, because a sample is guided to a column without passing through a flow path which has a groove shape and which is formed in the valve, carry-over is reduced.

On the other hand, in a case in which a needle is to be insertable into the direction injection valve, it is necessary to temporarily open a path into which the needle is to be inserted. In this case, it is considered that a mobile phase having a high pressure leaks from the path into which the needle is to be inserted. Therefore, a decrease in pressure of the mobile phase to be sent in a liquid chromatograph, a backward flow of the mobile phase in the column, and the like occur. In this manner, in a case in which the liquid chromatograph does not work properly, analysis accuracy of the liquid chromatograph is degraded.

An object of the present disclosure is to provide a flow-path switching device and a liquid chromatograph that are capable of analyzing a sample with higher accuracy while suppressing leakage of a mobile phase.

A first aspect of the present disclosure relates to a flow-path switching device for introducing a sample into a separation column, including a column pipe connected to the separation column, a first rotating body which has a first port and a first sliding surface, and in which a first through hole penetrating the first port and the first sliding surface is formed, and a second rotating body having a second sliding surface facing the first sliding surface, wherein the second rotating body is rotatable with the first sliding surface being in contact with the second sliding surface, and a second through hole is formed in the second rotating body, one end of the second through hole is connectable to the first through hole when a rotation position of the second rotating body with respect to the first rotating body is a first position, and another end of the second through hole is connected to the column pipe.

A second aspect of the present disclosure relates to a liquid chromatograph including the above-mentioned flow-path switching device.

With the present disclosure, it is possible to analyze a sample with higher accuracy while suppressing leakage of a mobile phase.

Other features, elements, characteristics, and advantages of the present disclosure will become more apparent from the following description of preferred embodiments of the present disclosure with reference to the attached drawings.

### BRIEF DESCRIPTION OF THE DRAWING

FIG. 1 is a schematic diagram showing the configuration of a liquid chromatograph according to one embodiment of the present disclosure;

FIG. 2 is a cross-sectional view of a flow-path switching device of FIG. 1 taken along the line X-X;

FIG. 3 is an enlarged view of a portion Z of FIG. 2;

FIG. 4 is a cross-sectional view of the flow-path switching device of FIG. 1 taken along the line Y-Y;

FIG. 5 is a schematic plan view of the flow-path switching device of FIG. 1;

FIG. 6 is a schematic plan view of the flow-path switching device of FIG. 1;

FIG. 7 is a schematic diagram of a liquid chromatograph for explaining one example of an analysis operation; and

FIG. 8 is a schematic diagram of the liquid chromatograph for explaining the one example of the analysis operation.

### DETAILED DESCRIPTION

A flow-path switching device and a liquid chromatograph according to embodiments of the present disclosure will be described below in detail with reference to the drawings.

### (1) Configuration of Liquid Chromatograph

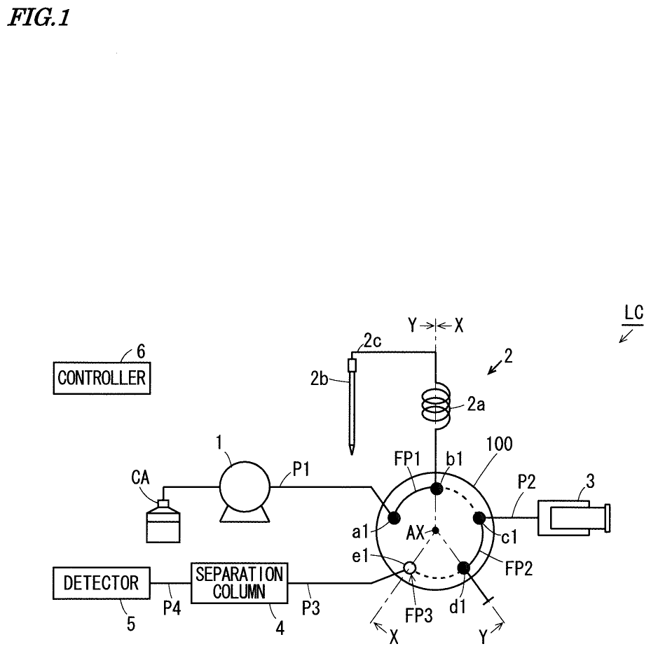

FIG. 1 is a schematic diagram showing the configuration of a liquid chromatograph according to one embodiment of the present disclosure. The liquid chromatograph LC of FIG. 1 is a nano LC, for example. The diameter of a pipe that forms the liquid chromatograph LC is set in the range of 10 to 50 μm. The liquid chromatograph LC includes a flow-path switching device 100, an analysis pump 1, a sample injector 2, a syringe 3, a separation column 4, a detector 5 and a controller 6.

The flow-path switching device 100 is a rotary-type valve having ports a1 to e1. The flow-path switching device 100 further includes flow paths FP1 to FP3. The flow path FP1 and the flow path FP2 are groove-shaped flow paths that connect two adjacent ports among the ports a1 to e1. The ports a1 to e1 are ports provided in a stator included in the flow-path switching device 100. In contrast, the flow paths FP1 to FP3 are flow paths provided in a rotor included in the flow-path switching device 100. As described below, the rotor rotates with respect to the stator in the flow-path switching device 100, so that the positional relationship between the ports a1 to e1 and the flow paths FP1 to FP3 changes. Details of the flow-path switching device 100 will be described below.

A pipe P1 is connected to an analysis pump 1. The analysis pump 1 sends a mobile phase stored in a container CA to the pipe P1. The mobile phase is an eluent obtained when water and an organic solvent are mixed at a predetermined ratio. The organic solvent is acetonitrile or methanol, for example. The analysis pump 1 is connected to the port a1 of the flow-path switching device 100 through the pipe P1.

The sample injector 2 includes a sample loop 2a, a needle 2b and a connection pipe 2c. The needle 2b is connected to the sample loop 2a through the connection pipe 2c. The needle 2b of the sample injector 2 is movable in a horizontal direction and a vertical direction by a movement mechanism (not shown). The sample loop 2a is connected to the port b1 of the flow-path switching device 100.

The syringe 3 is a syringe pump, for example, and is connected to a pipe P2. The syringe 3 can suck and discharge a sample through the pipe P2. The syringe 3 is connected to the port c1 of the flow-path switching device 100 through the pipe P2. A closing pipe for closing a flow path is connected to the port d1 of the flow-path switching device 100. The port e1 of the flow-path switching device 100 is a hole into which the needle 2b of the sample injector 2 can be inserted. The flow path FP3 is connected to the separation column 4 through a column pipe P3. The separation column 4 is connected to the detector 5 through the pipe P4. The detector 5 is a mass spectrometer, for example, and sequentially detects components of a sample eluted from the separation column 4.

The controller 6 includes a CPU (Central Processing Unit), a ROM (Read Only Memory), a RAM (Random Access Memory) and a storage device, for example. An analysis program for performing an analysis operation, described below, is stored in the ROM or the storage device included in the controller 6. The controller 6 is implemented by execution of a computer program such as the analysis program stored in the ROM or the storage device on the RAM. Part or all of the controller 6 may be constituted by hardware such as an electronic circuit. The controller 6 performs the analysis operation, described below, by controlling the respective components of the analysis pump 1, the detector 5 and the flow-path switching device 100 based on the analysis program.

### (2) Configuration of Flow-Path Switching Device 100

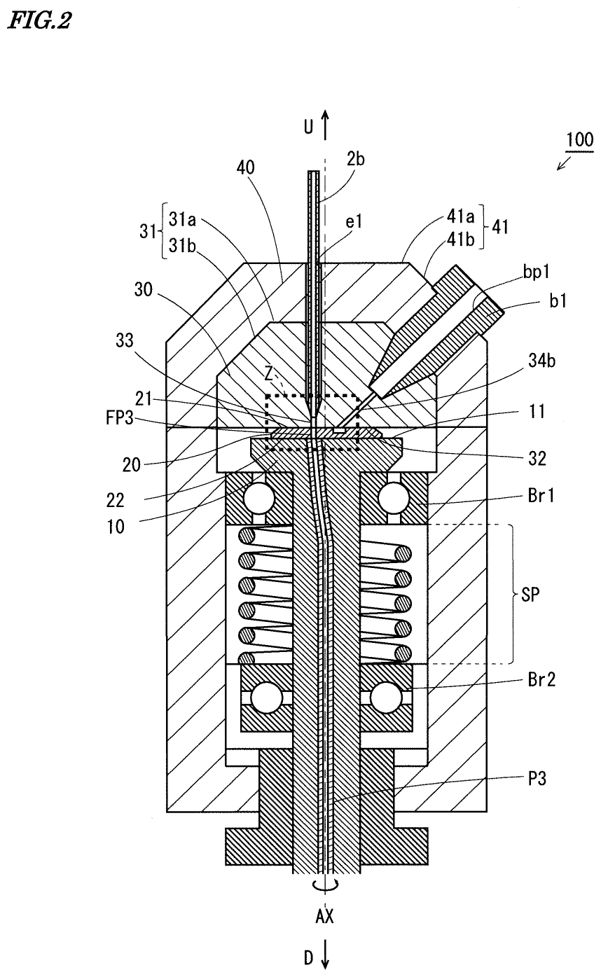

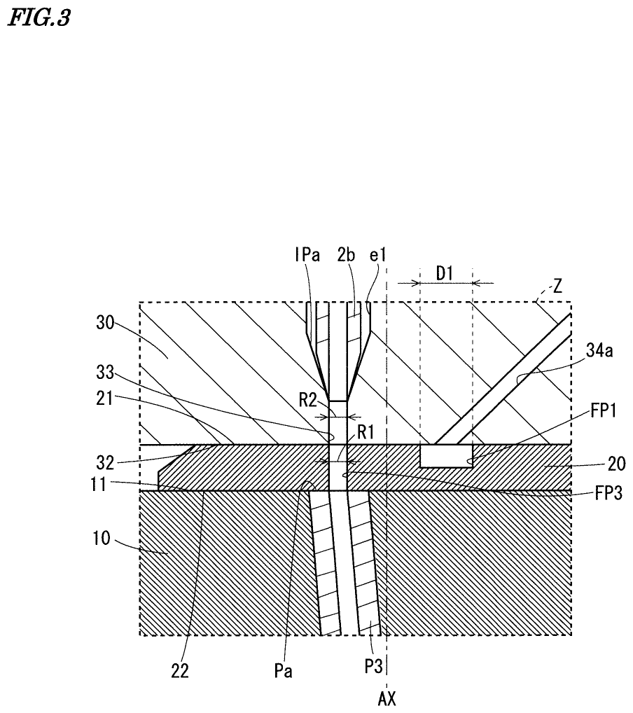

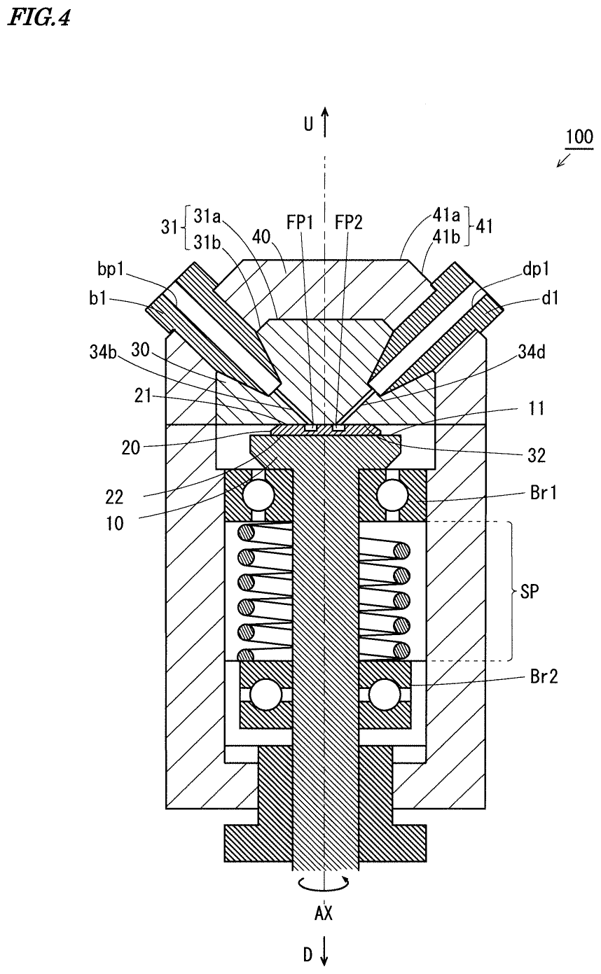

FIG. 2 is a cross-sectional view of the flow-path switching device 100 of FIG. 1 taken along the line X-X. FIG. 3 is an enlarged view of a portion Z of FIG. 2. FIG. 4 is a cross-sectional view of the flow-path switching device 100 of FIG. 1 taken along the line Y-Y. In FIG. 2, the needle 2b (see FIG. 1) of the sample injector 2 is inserted into the port e1 of the flow-path switching device 100, by way of example. In the following description, the arrow U indicates an upward direction of the flow-path switching device 100, and the arrow D indicates a downward direction of the flow-path switching device 100. Further, an axis extending linearly in an upward-and-downward direction is referred to as a first axis AX.

With reference to FIGS. 2 and 3, the flow-path switching device 100 includes the column pipe P3, a holding member 10, the rotor 20, the stator 30 and a housing 40. The holding member 10 has a cylindrical shape extending in the upward-and-downward direction and centered at the first axis AX. The column pipe P3 is a pipe having one end and another end Pa. The one end of the column pipe P3 is connected to the separation column 4 of FIG. 1. The column pipe P3 is curved while extending in the upward-and-downward direction. In other words, the column pipe P3 is partially curved while extending along the first axis AX. Thus, the other end Pa of the column pipe P3 is separated from the first axis AX.

The holding member 10 has an upper surface 11. In the present embodiment, the holding member 10 is formed of metal. The metal used for the holding member 10 is SUS, for example. The holding member 10 may be formed of resin. The holding member 10 covers the column pipe P3 extending in the upward-and-downward direction. The other end Pa of the column pipe P3 is exposed on the upper surface 11 of the holding member 10.

The rotor 20 is joined onto the upper surface 11 of the holding member 10. The rotor 20 is formed of metal. The metal is SUS, for example. The rotor 20 may be formed of resin. The rotor 20 has a flat plate shape, and has an upper surface 21 and a lower surface 22. In the present embodiment, the rotor 20 is formed of metal, so that the upper surface 21 of the rotor 20 is metal. The upper surface 21 of the rotor 20 may be coated with resin. As shown in FIG. 3, the flow path FP1 that has a groove shape, and extends in an arc shape and in the horizontal direction is formed in the upper surface 21 of the rotor 20. The width D1 of the flow path FP1 is 100 to 300 μm. As shown in FIG. 4, the flow path FP2 that has a different groove shape from that of the flow path FP1, and extends in an arc shape and in the horizontal direction is formed on the upper surface 21 of the rotor 20. The width of the flow path FP2 is the same as the width D1 of the flow path FP1.

Referring back to FIGS. 2 and 3, the flow path FP3 penetrating the upper surface 21 and the lower surface 22 is formed in the rotor 20. The flow path FP3 is a through hole extending in the direction intersecting with the upper surface 21 and the lower surface 22. In the present embodiment, the flow path FP3 extends in the upward-and-downward direction. The flow path FP3 is formed by machining processing such as drilling. A diameter R1 of the flow path FP3 is set in the range of 50 to 100 μm. The lower end of the flow path FP3 and the other end Pa of the column pipe P3 overlap with each other in top view. The lower surface 22 of the rotor 20 is joined to the upper surface 11 of the holding member 10 and the other end Pa of the column pipe P3. While being joined by welding in the present embodiment, the lower surface 22 of the rotor 20 and the other end Pa of the column pipe P3 may be joined by brazing. A spring SP is provided in a lower portion of the holding member 10 and a lower portion of the rotor 20. The spring SP is a compression spring, for example, and pushes the rotor 20 upwardly through the holding member 10.

The stator 30 is provided on the upper side of the rotor 20. The housing 40 covers the holding member 10, the rotor 20 and the stator 30. The housing 40 is formed of metal, for example. The upper surface 41 of the housing 40 includes a horizontal surface 41a, and an inclined surface 41b that is inclined with respect to the horizontal surface 41a. The port e1 is formed in the horizontal surface 41a. The port e1 is a needle port. The port e1 is a hole extending downwardly from the horizontal surface 41a. The diameter of the port e1 is set such that the needle 2b can be inserted into the port e1. The port b1 having a flow path bp1 is provided in the inclined surface 41b.

As shown in FIG. 4, the port d1 is provided in the inclined surface 41b similarly to the port b1. The port d1 is a connection member that can connect the pipe and the flow-path switching device 100 to each other, similarly to the port b1. Although not shown in the cross-sectional view, the port a1 and the port c1 are respectively provided in the inclined surface 41b, similarly to the port b1 and the port d1.

Referring back to FIGS. 2 and 3, the stator 30 is formed of resin. The resin used for the stator 30 is PEEK (polyether ether ketone), for example. The stator 30 may be formed of metal. The stator 30 has a cylindrical shape having an upper surface 31 and a lower surface 32. The upper surface 21 of the rotor 20 comes into contact with part of the lower surface 32 of the stator 30 due to upward pressing of the spring SP. The upper surface 21 of the rotor 20 and the lower surface 32 of the stator 30 are slidable while being in contact with each other.

The upper surface 31 of the stator 30 includes a horizontal surface 31a, and an inclined surface 31b that is inclined with respect to the horizontal surface 31a. The port e1 is formed in the horizontal surface 31a. The port e1 is continuous from the housing 40. In the stator 30, the port e1 extends downwardly from the horizontal surface 31a. A needle seal portion IPa is formed below the port e1. When the needle 2b is connected, the tip of the needle 2b is pressed against the needle seal portion IPa.

In the stator 30, a through hole 33 penetrating from the lower end of the needle seal portion IPa to the lower surface 32 is formed. The through hole 33 extends in the direction intersecting with the lower surface 32. In the present embodiment, the through hole 33 extends in the upward-and-downward direction. The through hole 33 is formed by machining processing such as drilling. The diameter of the through hole 33 is set smaller than the diameter of the port e1. Further, a diameter R2 of the through hole 33 is set smaller than the widths of the flow paths FP1, FP2. Specifically, the diameter R2 of the through hole 33 is set in a range of 50 to 100 μm. In the present embodiment, the diameter R2 of the through hole 33 is equal to the diameter R1 of the flow path FP3 of the rotor 20.

The port b1 is inserted into the inclined surface 31b of the stator 30. In the stator 30, a through hole 34b penetrating from the lower end of the port b1 to the lower surface 32 is formed. As shown in FIG. 4, the port d1 is inserted into the inclined surface 31b similarly to the port b1. In the stator 30, the through hole 34d corresponding to the port d1 is formed similarly to the through hole 34b. Although not shown in the cross-sectional view, the port a1 and the port c1 are respectively inserted into the inclined surface 31b, similarly to the port b1 and the port d1. Further, in the stator 30, the through holes respectively corresponding to the port a1 and the port c1 are formed.

The holding member 10 is connected to a driving mechanism (not shown) such as a motor for rotating the holding member 10 about the first axis AX. The holding member 10 is rotatably supported by bearings Br1, Br2, and rotates about the first axis AX. Here, the rotor 20 is joined to the holding member 10. Further, the column pipe P3 is covered by the holding member 10. Thus, with the upper surface 21 being in contact with the lower surface 32 of the stator 30, the rotor 20 and the column pipe P3 rotate about the first axis AX integrally with the holding member 10. The position of the flow path FP3 with respect to the through hole 33 of the stator 30 after the rotor 20 rotates with respect to the fixed stator 30 is referred to as a rotation position. When the rotation position is the first position, the flow path FP3 of the rotor 20 and the through hole 33 of the stator 30 overlap with each other in top view. The state of the flow-path switching device 100 with the rotation position being the first position is referred to as a state A. The state of the flow-path switching device 100 with the rotation position being a second position different from the first position is referred to as a state B. The flow-path switching device 100 can be switched between the state A and the state B.

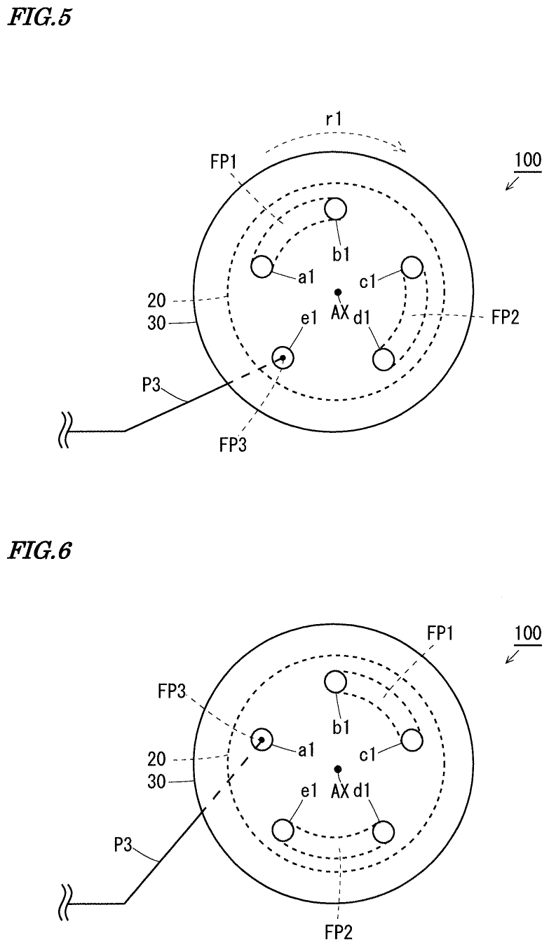

FIGS. 5 and 6 are schematic plan views of the flow-path switching device 100 of FIG. 1. In FIGS. 5 and 6, in order to describe the connection relationship among the flow paths in an easily understandable manner, shading is not applied to the ports a1 to d1. FIG. 5 shows the flow-path switching device 100 in the state A. As shown in FIG. 5, in the state A, the port a1 and the port b1 are connected by the flow path FP1, and the port c1 and the port d1 are connected by the flow path FP2. Further, the port e1 is connected to the column pipe P3 by the flow path FP3. As indicated by the dotted arrow r1, when the rotor 20 is rotated about the first axis AX with respect to the stator 30 in the state A, the positions of the flow paths FP1 to FP3 change with respect to the ports a1 to e1 fixed by the stator 30. Thus, the flow-path switching device 100 enters the state B.

FIG. 6 shows the flow-path switching device 100 in the state B. As shown in FIG. 6, in the state B, the port b1 and the port c1 are connected by the flow path FP1, and the port d1 and the port e1 are connected by the flow path FP2. Further, the port a1 is connected to the column pipe P3 by the flow path FP3. In this manner, the port to which the column pipe P3 is connected is switched to either the port a1 or the port e1 according to the switching of the states of the flow-path switching device 100. In a case in which the needle 2b is inserted into the port e1 (see FIG. 2) when the flow-path switching device 100 is in the state A, the needle 2b inserted into the port e1 is connected to the column pipe P3 through the flow path FP3. When the flow-path switching device 100 is in the state B, the analysis pump 1 connected to the port a1 is connected to the column pipe P3 through the flow path FP3.

### (3) Analysis Operation

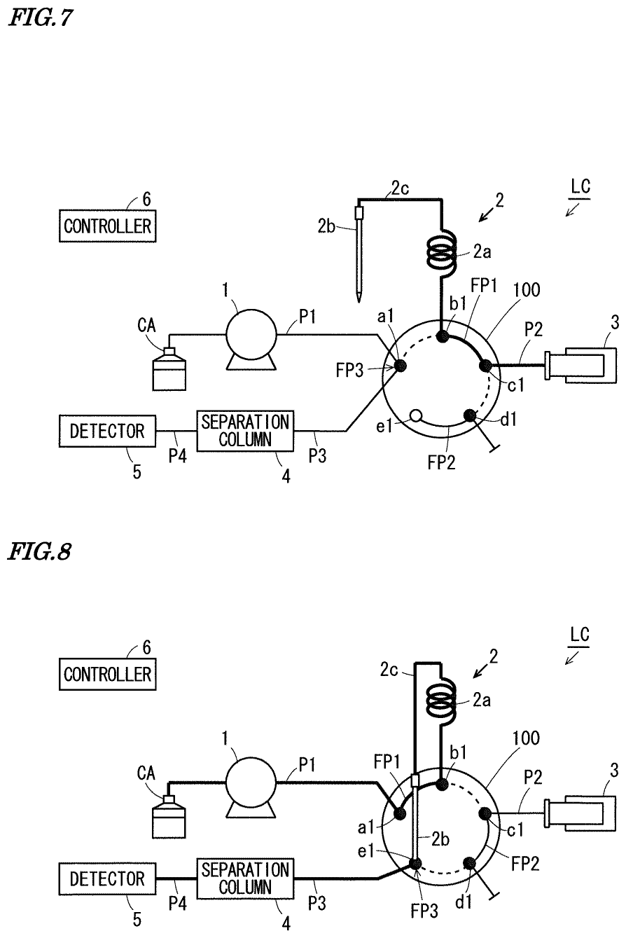

FIGS. 7 and 8 are schematic views of the liquid chromatograph LC for explaining one example of an analysis operation. In FIGS. 7 and 8, pipes through which a sample is flowing is indicated by the thick line. The below-mentioned process is executed by the control of the controller 6. First, the sample injector 2 executes a sample sucking process. Here, the flow-path switching device 100 is switched to the state B shown in FIG. 7. Thus, the sample injector 2 and the syringe 3 are connected to each other through the flow path FP1. Next, the movement mechanism (not shown) moves the needle 2b together with the connection pipe 2c. After the needle 2b is moved to a position above a sample container containing a sample to be analyzed, the needle 2b is lowered. Thus, the tip of the needle 2b is inserted into the sample container. In this state, the syringe 3 is operated. Thus, the sample to be analyzed is sucked from the needle 2b toward the syringe 3, and the sample is held in the sample loop 2a. The analysis pump 1 is operated during the sucking process. In this case, the mobile phase stored in the container CA is guided to the separation column 4 through the pipe P1, the port a1, the flow path FP3 and the column pipe P3.

Next, an analysis process is executed. First, since being inserted into the port e1, the needle 2b of the sample injector 2 is connected to the port e1 (see FIG. 2) of the flow-path switching device 100. Next, the flow-path switching device 100 is switched to the state A shown in FIG. 8, and the analysis pump 1 and the sample injector 2 are connected to each other through the flow path FP1. Thus, the analysis pump 1 is connected to the separation column 4 through the sample loop 2a of the sample injector 2, and starts an analysis.

The mobile phase stored in the container CA is guided to the pipe P1, the ports a1, b1 of the flow-path switching device 100, and the sample loop 2a. Thus, the sample held in the sample loop 2a is pushed out into the mobile phase. The mobile phase and the sample (hereinafter abbreviated as a sample) that have flowed out from the sample loop 2a are guided to the separation column 4 through the connection pipe 2c, the needle 2b, the port e1 of the flow-path switching device 100, and the column pipe P3. The sample that has passed through the separation column 4 is guided to the detector 5.

### (4) Effects of Embodiments

With the flow-path switching device 100 of the above-mentioned embodiment, a sample that has been supplied to the port e1 is guided to the column pipe P3 through the through hole 33 penetrating the stator 30 and the flow path FP3 penetrating the rotor 20. In this case, the sample does not pass through a flow path having a large diameter while being guided from the port e1 to the column pipe P3, so that an occurrence of extra-column dispersion of the sample and carry-over of the sample is suppressed. Further, the rotor 20 can be rotated relative to the stator 30 with the needle 2b being connected to the port e1 of the fixed stator 30. Thus, with the needle 2b being connected to the port e1 of the stator 30, the through hole 33 and the flow path FP3 can be connected to each other. Therefore, because it is possible to avoid connecting the through hole 33 to the flow path FP3 with the port e1 being open, it suppresses exposure of the column pipe P3 and the separation column 4 to an atmosphere pressure. Thus, a backward flow of liquid from the column pipe P3 to the port e1 can be suppressed. As a result, it is possible to introduce a sample in a suitable state into the separation column 4 while suppressing leakage of liquid.

Further, the rotor 20 rotates with respect to the fixed stator 30. In this case, because the rotor 20 rotates with the needle 2b being connected to the port e1 of the fixed stator 30, the needle 2b does not need to be rotated. This can suppress damage to the needle 2b.

Further, generally, in a case in which a groove (flow path) is formed along a sliding surface in a flow-path switching device, a sample that has been guided to the groove (flow path) of the sliding surface from above turns substantially vertically and then flows through the groove (flow path). In this case, because a turbulent flow is generated in a sample flowing through the groove (flow path), extra-column dispersion occurs. With the flow-path switching device 100 of the above-mentioned embodiment, because the flow path FP3 extends in the direction intersecting with the upper surface 21, it suppresses collision of a sample with the flow path. Further, the flow path FP3 penetrating in the upward-and-downward direction is processed by drilling, and the processing by drilling is easier than processing of a groove of the rotor 20. Therefore, the diameter can be reduced in manufacturing, and the difference between the diameter of the flow path FP3 and the diameter of the needle 2b, and the difference between the diameter of the flow path FP3 and the diameter of the connection pipe 2c can be reduced. As a result, extra-column dispersion is further suppressed.

Further, as shown in FIG. 3, when the needle 2b is connected to the port e1, the tip of the needle 2b is pressed against the needle seal portion IPa. Because being formed of resin, the stator 30 is relatively soft. Therefore, when the needle 2b is pressed against the needle seal portion IPa, the needle seal portion IPa is plastically deformed into the shape of the tip of the needle 2b. Thus, the through hole 33 can be accurately closed.

Further, because the holding member 10 and the rotor 20 are separate members, only the rotor 20 can be replaced according to the state of wear of the upper surface 21 of the rotor 20. This can prolong the service life of the flow-path switching device 100.

### (5) Other Embodiments

While the holding member 10 and the rotor 20 are separate members in the above-mentioned embodiment, the holding member 10 and the rotor 20 may be integrally formed of a single material. In this case, the holding member 10 and the rotor 20 can be easily manufactured.

### (6) Correspondences Between Constituent Elements in Claims and Parts in Preferred Embodiments

In the following paragraphs, non-limiting examples of correspondences between various elements recited in the claims below and those described above with respect to various preferred embodiments of the present disclosure are explained. The stator 30 is an example of a first rotating body, the lower surface 32 of the stator 30 is an example of a first sliding surface, and the through hole 33 is an example of a first through hole. Further, the rotor 20 is an example of a second rotating body, the upper surface 21 of the rotor 20 is an example of a second sliding surface, and the flow path FP3 is an example of a second through hole. Further, the port e1 is an example of a first port, the port c1 is an example of a second port, the port b1 is an example of a third port, and the port a1 is an example of a fourth port. Further, the flow path FP1 is an example of a first groove, and the flow path FP2 is an example of a second groove.

### (7) Aspects

It is understood by those skilled in the art that the plurality of above-mentioned illustrative embodiments are specific examples of the below-mentioned aspects.

(Item 1) A flow-path switching device according to one aspect for introducing a sample into a separation column, includes a column pipe connected to the separation column, a first rotating body which has a first port and a first sliding surface, and in which a first through hole penetrating the first port and the first sliding surface is formed, and a second rotating body having a second sliding surface facing the first sliding surface, wherein the second rotating body is rotatable with the first sliding surface being in contact with the second sliding surface, and a second through hole is formed in the second rotating body, one end of the second through hole is connectable to the first through hole when a rotation position of the second rotating body with respect to the first rotating body is a first position, and another end of the second through hole is connected to the column pipe.

In general, a groove is formed as a flow path in a flow-path switching device. A groove is formed when a cutting tool such as a drill moves while being in contact with the second rotating body, for example. Therefore, in a case in which the flow path is a groove, it is difficult to precisely form the flow path due to the nature of machine processing. Further, in a case in which the width of the flow path is relatively large, the flow path may be worn over time by liquid flowing through the flow path. In a case in which having hydrophobicity, a sample may adhere to the surface of the worn flow path. Thus, carry-over may occur. On the other hand, a through hole is formed by linear penetration of a drill or the like. In this case, a flow path can be formed more precisely as compared with a case in which a flow path is a groove. Therefore, the diameter of the flow path can be small as compared with a case in which the flow path is a groove.

With the flow-path switching device according to item 1, a sample that has been supplied to the first port is guided to the column pipe through the first through hole penetrating the first rotating body and the second through hole penetrating the second rotating body. In this case, because the sample does not pass through a flow path having a large diameter while being guided from the first port to the column pipe, an occurrence of extra-column dispersion of the sample and an occurrence of carry-over of the sample are suppressed.

Further, the first rotating body and the second rotating body can be rotated relative to each other with a mechanism, such as a needle, for injecting a sample being connected to the first port of the fixed first rotating body. Thus, the first through hole and the second through hole can be connected to each other with the mechanism for injecting a sample being connected to the first port of the first rotating body. Therefore, because it is possible to avoid connecting the first through hole and the second through hole to each other with the first port being opened, it suppresses exposure of the column pipe to an atmospheric pressure. Thus, a backward flow of liquid from the column pipe to the first port can be suppressed. As a result, it is possible to introduce a sample in a suitable state into the separation column while suppressing leakage of liquid.

(Item 2) The flow-path switching device according to item 1, wherein the first rotating body may be fixed, and the second rotating body may rotate with respect to the first rotating body.

With the flow-path switching device according to item 2, the first rotating body is fixed during rotation of the second rotating body. In this case, because the second rotating body rotates with the needle being connected to the first port of the fixed first rotating body, it is not necessary to rotate the needle. Therefore, it is possible to suppress damage to a mechanism, such as a needle, for injecting a sample.

(Item 3) The flow-path switching device according to item 1 or 2, wherein the second rotating body may have a groove extending in a direction that intersects with the second through hole, and the second through hole may extend in a direction that intersects with the second sliding surface.

In a case in which a groove is formed along a sliding surface in the flow-path switching device, a sample that has been guided from above turns substantially vertically and then flows through the groove. In this case, because a turbulent flow is generated in the sample flowing through the groove (flow path), extra-column dispersion occurs. With the flow-path switching device according to item 3, because the second through hole extends in the direction intersecting with the second sliding surface, collision of a sample with the flow path is suppressed as compared with a case in which a groove is formed along the second sliding surface. Thus, extra-column dispersion is further suppressed.

(Item 4) The flow-path switching device according to any one of items 1 to 3, wherein the first rotating body may be formed of resin.

With the flow-path switching device according to item 4, because the first port is made of resin, in a case in which a mechanism, such as a needle, for injecting a sample is pressed against the first port, the first port is plastically deformed. Therefore, the needle can be connected to the first port more accurately.

(Item 5) The flow-path switching device according to any one of items 1 to 4, wherein the second sliding surface may be formed of metal.

With the flow-path switching device according to item 5, because the second sliding surface is formed of metal, generation of dust due to wear is suppressed.

(Item 6) The flow-path switching device according to any one of items 1 to 5, wherein the second rotating body and the column pipe may be joined to each other by welding or brazing.

With the flow-path switching device according to item 6, because the second rotating body and the column pipe are joined, the column pipe can be rotated along with the rotation of the second rotating body. Thus, it is possible to connect the separation column to the second through hole of the second rotating body at all times. Further, because the first sliding surface and the second sliding surface are in contact with each other, exposure of the column pipe and the separation column to an atmospheric pressure is suppressed.

(Item 7) The flow-path switching device according to any one of items 1 to 6, wherein the first rotating body may include a second port connected to a syringe, and a third port connected to a sample loop holding a sample, and the second sliding surface may be formed with a first groove by which the second port is connectable to the third port when a rotation position of the second rotating body with respect to the first rotating body is a second position.

With the injection port according to item 7, when the rotation position of the second rotating body with respect to the first rotating body is the second position, the syringe and the sample loop are indirectly connected to each other through the first groove. Thus, a sample can be sucked into the sample loop.

(Item 8) The flow-path switching device according to item 7, wherein the sample loop may be connected to a needle with which a sample is suckable and dischargeable, the first rotating body may further include a fourth port connected to an analysis pump that sends a mobile phase, the first through hole may be closed when the needle is connected to the first port, and the third port may be connectable to the fourth port by the first groove when a rotation position of the second rotating body with respect to the first rotating body is the first position.

With the flow-path switching device according to item 8, the needle is connected to the first port with a sample held in the sample loop. In this state, in a case in which the rotation position of the second rotating body with respect to the first rotating body is the first position, the analysis pump is indirectly connected to the needle through the sample loop and the first groove. When a mobile phase is sent by the analysis pump, the sample held in the sample loop is discharged from the needle. The sample is guided to the column pipe through the first through hole of the first rotating body and the second through hole of the second rotating body, and then guided to the separation column. In this manner, because the sample does not pass through a flow path having a large diameter until being guided from the sample loop to the separation column, extra-column dispersion is suppressed. Therefore, it is possible to provide a liquid chromatograph capable of more sufficiently improving analysis accuracy.

(Item 9) A liquid chromatograph according to another aspect includes the flow-path switching device according to any one of items 1 to 8.

With the liquid chromatograph according to item 9, a sample can be analyzed more accurately.

While preferred embodiments of the present disclosure have been described above, it is to be understood that variations and modifications will be apparent to those skilled in the art without departing the scope and spirit of the present disclosure. The scope of the present disclosure, therefore, is to be determined solely by the following claims.

I/We claim:

1. A flow-path switching device for introducing a sample into a separation column, comprising:
a column pipe connected to the separation column;
a first rotating body which has a first port and a first sliding surface, and in which a first through hole penetrating the first port and the first sliding surface is formed; and
a second rotating body having a second sliding surface facing the first sliding surface, wherein
the second rotating body is rotatable with the first sliding surface being in contact with the second sliding surface, and
a second through hole is formed in the second rotating body, one end of the second through hole is connectable to the first through hole when a rotation position of the second rotating body with respect to the first rotating body is a first position, and another end of the second through hole is connected to the column pipe.

2. The flow-path switching device according to claim 1, wherein
the first rotating body is fixed, and the second rotating body rotates with respect to the first rotating body.

3. The flow-path switching device according to claim 1, wherein
the second rotating body has a groove extending in a direction that intersects with the second through hole, and
the second through hole extends in a direction that intersects with the second sliding surface.

4. The flow-path switching device according to claim 1, wherein
the first rotating body is formed of resin.

5. The flow-path switching device according to claim 1, wherein
the second sliding surface is formed of metal.

6. The flow-path switching device according to claim 1, wherein
the second rotating body and the column pipe are joined to each other by welding or brazing.

7. The flow-path switching device according to claim 1, wherein
the first rotating body includes
a second port connected to a syringe, and
a third port connected to a sample loop holding a sample, and
the second sliding surface is formed with a first groove by which the second port is connectable to the third port when a rotation position of the second rotating body with respect to the first rotating body is a second position.

8. The flow-path switching device according to claim 7, wherein
the sample loop is connected to a needle with which a sample is suckable and dischargeable,
the first rotating body further includes a fourth port connected to an analysis pump that sends a mobile phase,
the first through hole is closed when the needle is connected to the first port, and
the third port is connectable to the fourth port by the first groove when a rotation position of the second rotating body with respect to the first rotating body is the first position.

9. A liquid chromatograph comprising the flow-path switching device according to claim 1.
